(19) United States
(12) Patent Application Publication
(10) Pub. No.: US 2003/0194491 A1
(43) Pub. Date: Oct. 16, 2003

(54) Method of preparing an anti-fouling coating

(76) Inventors: Harris Gold, Lexington, MA (US); Rhonda D. Levy, Hopkinton, MA (US); Marina Temchenko, Swampscott, MA (US); Thomas H.E. Mendum, Somerville, MA (US); Toyoichi Tanaka, Wellesley, MA (US); Takashi Enoki, Kanagawa (JP); Guoqiang Wang, Belmont, MA (US); Tomoko Tanaka, Wellesley, MA (US)

Correspondence Address: IANDIORIO & TESKA, 260 BEAR HILL ROAD, WALTHAM, MA, 02451-1018, US

(21) Appl. No.: 10/197,511

(22) Filed: Jul. 17, 2002

Related U.S. Application Data
(60) Provisional application No. 60/305,944, filed on Jul. 17, 2001.

(51) Int. Cl. B05D 7/00

(52) U.S. Cl. 427/212

(57) ABSTRACT

A method of preparing an anti-fouling coating, the method including the steps of soaking polymeric gel beads in the presence of a solution including a solvent and a biocide to swell the gel beads and absorb both the solvent and the biocide therein, evaporating the solvent, rinsing any biocide of the surface of the beads, and mixing the beads in a coating material. APPLICATION FOR UNITED STATES LETTERS PATENT

Be it known that we, Harris Gold, residing at 18 Peachtree Road, Lexington, Massachusetts 02420 and being a citizen of the United States of America; Rhonda D. Levy, residing at 53 Ash Street, Hopkinton, Mass. 01748 and being a citizen of the United States; Marina Temchenko, residing at 15 Sherwood Road, Swampscott, Mass. 01907 and being a citizen of the United States; Thomas H.E. Mendum residing at 102 Glenwood Road, No. 1, Somerville, Mass. 02145 and being a citizen of the United States; Toyoichi Tanaka, deceased; Takashi Enoki, residing at ______and being a citizen of Japan; and Guoquiang Wang, 63 Creeley Road, Belmont, Mass. 02478 and being a citizen of China have invented a certain new and useful

### RELATED APPLICATIONS

This application claims priority of Provisional Application No. 60/305,944 filed Jul. 17, 2001, incorporated by reference herein.

### GOVERNMENT RIGHTS

This invention was made with U.S. Government support under Contract Nos. N00014-96-C-0355; N00014-98-C-0083; and N00014-00-M-0196 awarded by the Office of Naval Research, Arlington, Va. 22217. The Government may have certain rights in the subject invention.

### FIELD OF THE INVENTION

This invention relates to anti-fouling coatings and more particularly to an improved method of preparing an anti-fouling coating which provides for prolonged, controlled release of a biocide.

### BACKGROUND OF THE INVENTION

Marine engineered systems, such as ships, floating platforms, seawater piping systems and other fixed structures located in seawater near the surface will quickly support a variety of marine bio-fouling communities such as soft-fouling organisms, e.g., algae and invertebrates, and hard-fouling species, e.g., barnacles and mussels. Countermeasures against these damaging bio-fouling communities attempting to establish residence on the surfaces of marine engineered systems is a major challenge. Prior art countermeasures, by necessity, are intended to be toxic to the bio-fouling communities and thus raise many environmental and human health issues.

In marine vessels, bio-fouling is very costly because excess fuel is required to overcome the increased hydrodynamic drag on the hull of a bio-fouled vessel, as well as the costs associated with the application, maintenance, and removal of anti-fouling coatings. Bio-fouling of Navy ships results in lost Naval force capability because the bio-fouled ships are unable to achieve their designed speeds or range. Moreover, the downtime required for the foulant removal and/or the maintenance of anti-fouling coatings further reduces Naval capability.

Typical prior art anti-fouling coatings unitize toxic biocides made of metal-containing compounds such as mercury, arsenic, tin, copper, zinc, silver, chromium, barium, and selenium. One prior art anti-fouling coating as used by the U.S. Navy is F121, a formula of red cuprous oxide and vinyl rosin anti-fouling coating. However, the effective lifetime of F121 does not meet the typical 5 to 7 year dry-docking interval that ships undergo for servicing of various on-board mechanical equipment. Moreover, in the period between dry-docking, a green layer of insoluble copper salts often forms blocking further release of the copper and rendering the F121 anti-fouling coating ineffective.

Other prior art anti-fouling coatings or paints utilize the biocide tributyltin (TBT). Although this anti-fouling coating is effective, it is unduly toxic to the environment. The U.S. Congress at one time prohibited the Navy from applying or purchasing organotin (e.g., tributyltin) coatings because TBT levels in marine and freshwater environments were found to cause acute and chronic effects on other aquatic organisms.

Another prior art anti-fouling coating utilizes the biocide ablative cuprous oxide. Although the performance of ablative cuprous oxide coatings exceeds the standard of F121, it does not match the length of effectiveness of ablative tin, even when a special underwater brushing technique for cleaning hulls is used.

A new organic anti-foulant biocide, SEA-NINE™ 211, which contains isothiazolone in 30 percent xylene, has recently been developed. SEA-NINE™ 211 has a very low molecular weight (280 daltons), a solubility in seawater of only a few ppm, and rapidly degrades in seawater, with a half-life of less than 24 hours. SEA-NINE™ 211 does not accumulate in the environment and hence minimizes the long-term threat to non-fouling aquatic species.

Prior art methods formulating SEA-NINE™ 211 into conventional soluble matrix anti-fouling coatings, in conjunction with cuprous oxide, have been shown to be effective against a wide variety of soft and hard type fouling organism. However, because SEA-NINE™ 211 has greatly enhanced (accelerated) release rate in seawater, these prior art anti-fouling coatings cannot provide controlled, prolonged release of SEA-NINE™ 211 and hence have a short coating lifetime and require frequent hull applications.

### SUMMARY OF THE INVENTION

It is therefore an object of this invention to provide an improved method of preparing an anti-fouling coating.

It is a further object of this invention to provide such a method of preparing an anti-fouling coating which preferably utilizes a biocide.

It is a further object of this invention to provide such a method in which the resulting protective coating releases the biocide at a controlled, constant rate when exposed to water, seawater, or paint formulations.

It is a further object of this invention to provide such a method in which the coating releases a biocide at a rate of less than 10 μg/cm²/day.

It is a further object of this invention to provide such a method in which the coating which has an effective lifetime of 5 to 7 years.

It is a further object of this invention to provide such a method in which the protective coating is effective against common soft and hard fouling organisms on the hull of a sea vessel or other structure located in seawater.

It is a further object of this invention to provide such a method of preparing an anti-fouling coating in which polymeric gel beads are utilized to encapsulate the biocide.

It is a further object of this invention to provide such a method in which the size of the polymeric gel bead does not affect the properties of the coating.

The invention results from the realization that a truly innovative method for preparing an anti-fouling coating which releases a biocide at a controlled, prolonged release rate when exposed to water, seawater or paint formulations is achieved, not by utilizing biocides which cannot provide effective anti-fouling for periods of up to 5 to 7 years, but instead, by a simple and efficient method, which, in one embodiment, utilizes a unique combination of a biocide, small polymeric gel beads, and a solvent. Typically, the gel beads are soaked in a solution of the solvent and the biocide and the solvent causes the gel beads to swell and absorb both the solvent and the biocide therein, the solvent is then evaporated and the biocide is rinsed off the surface of the beads. The gel beads with encapsulated biocide therein are then mixed in a protective coating, such as paint. This invention results from the further realization that another innovative method of preparing an anti-fouling coating is achieved by synthesizing polymeric gel beads in the presence of a biocide to encapsulate the biocide into the beads and mixing the beads with a protective coating.

This invention features a method of preparing an anti-fouling coating, the method including the steps of soaking polymeric gel beads in the presence of a solution including a solvent and a biocide to swell the beads and absorb both the solvent and the biocide therein, evaporating the solvent, rinsing any biocide of the surface of the beads, and mixing the beads in a coating material.

In one embodiment, the method utilizes beads that have a diameter of less than 200 μm. In other designs, the beads have a diameter of less than 50 μm. Ideally, the polymeric gel beads are made of polystyrene. Typically, the polymeric gel beads are soaked in the presence of the solvent and the biocide for more than 12 hours. In one example, the solvent is xylene. In other examples, the solvent is chosen from the group consisting of acetone, benzene, toluene, chloroform, dichloroform, dichloromethane, and tetrahydrofuran.

In a preferred embodiment, the biocide is a 30 percent solution of 4,5-dichloro-2N-octyl-4-isothiazolin-3-one in xylene, SEA-NINE™ 211. In other examples the biocide is IRGAROL® 1051, or copper. In other examples, the biocide is a mixture of copper and SEA-NINE™ 211 or a mixture of copper and IRGAROL® 1051. Ideally, the method of preparing an anti-fouling coating encapsulates twenty percent or more of the biocide in the gel beads.

In a preferred embodiment, the method of preparing an anti-fouling coating utilizes the gel beads which are chosen such that they remain collapsed when exposed to seawater or paint formulations.

In one example, the release rate of the biocide from the gel beads mixed in the protective coating is less than 10 μg/cm²/day. In other examples, the release rate of a chosen biocide from the gel beads mixed in a protective coating is sufficient to inhibit the attachment of fouling organisms to the surface of a marine vessel.

Typically, the effective lifetime of the anti-fouling coating is in the range of 5 to 7 years. The coating may be paint. In one example, the anti-fouling coating of this invention is applied to the hull of a sea vessel, floating platforms, seawater piping systems, or other fixed structures located near the surface of the sea.

This invention further features a method of preparing an anti-fouling coating, the method including the steps of soaking polymeric gel beads in the presence of a solution including a solvent and a biocide to swell the beads and absorb both the solvent and the biocide therein, evaporating the solvent, and mixing the beads in a protective coating.

This invention also features a method of preparing an anti-fouling coating, the method including the steps of choosing polymeric gel beads which remain collapsed when exposed to seawater and paint formulations, soaking the polymeric beads in the presence of a solution including a solvent and a biocide to swell the beads and absorb both the solvent and the biocide therein, evaporating the solvent to collapse the beads, and mixing the beads in a coating material.

This invention further features a method of preparing an anti-fouling coating, the method including the steps of encapsulating a biocide in polymeric gel beads, and mixing the beads in a protective coating.

This invention also features a method of preparing an anti-fouling coating, the method including the steps of synthesizing gel beads in the presence of a biocide to encapsulate the biocide in the beads, and mixing the beads in a protective coating. The method may further include the steps of washing the polymeric beads to remove biocide from the surface of the beads, and grinding the polymeric beads to a diameter of less than 50 μm. In one embodiment, the biocide is solid, such as copper, 4,5-dichloro-2-N-octyl-4-isothiazolin-3-one, or IRGAROL® 1051. In other examples, the biocide is SEA-NINE™ 211 (isothiazolone in xylene), or IRGAROL™ 1051 (s-triazine in chloroform). Ideally, the polymeric gel beads are synthesized by free-radical polymerization. The monomers that are polymerized are typically chosen such that the polymer chains will interact by hydrogen bonding, electrostatic interaction, van der Waals interaction, or hydrophobic interactions. In one example, the monomers are chosen from the group consisting of MAPTA, AMPS, methacrylic acid and dimethylacrylamide.

### BRIEF DESCRIPTION OF THE DRAWINGS

Other objects, features and advantages will occur to those skilled in the art from the following description of a preferred embodiment and the accompanying drawings, in which:

FIG. 1 is a graph showing the release rate of a prior art biocide from a protective coating applied to a sea vessel or other sea structure;

FIG. 2 is a three-dimensional view showing an example of both a collapsed and swollen polymeric gel bead in accordance with this invention;

FIG. 3 is a flowchart depicting the primary steps associated with one method of preparing an anti-fouling coating in accordance with the present invention;

FIG. 4 is a depiction of the structure of the active ingredient 4,5-dichloro-2-N-octyl-4-isothiazolin-3-one in SEA-NINE™ 211 as used in accordance with the preferred method of preparing an anti-fouling coating in accordance with this invention;

FIG. 5 is a depiction of the structure of the biocide IRGAROL® useful in accordance with another method of preparing an anti-fouling coating in accordance with this invention;

FIG. 6 is a graph showing the release rates of the biocide from the protective coating when the methods of this invention are employed;

FIG. 7 is a flowchart depicting the primary steps associated with another method of preparing anti-fouling coatings in accordance with this invention;

FIG. 8 is a flowchart depicting the primary steps associated with of one method of preparing anti-fouling coatings of this invention in which the polymeric beads are synthesized in the presence of a biocide; and

FIG. 9 is a depiction of the structure of several monomers used in one embodiment of this invention to synthesize polymeric gel beads.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details and arrangements set forth in the following description or illustrated in the drawings.

As explained in the Background section above, typical prior art anti-fouling coatings for ships and other engineered structures located in seawater utilize toxic anti-fouling biocides, such as metals, mercury, arsenic, tin, copper, zinc, silver, chromium, barium, and selenium. Other prior art anti-fouling coatings use organotin compounds, e.g., tributyltin (TBT), or ablative cuprous oxide. Some of these prior art anti-fouling coatings are damaging to the marine environment and also have an effective lifetime which does not meet the typical 5 to 7 year docking interval that ships undergo for servicing.

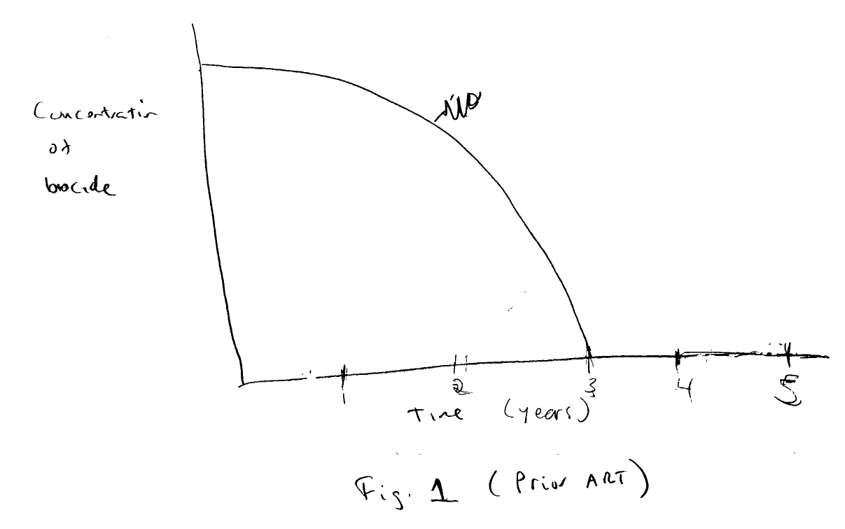

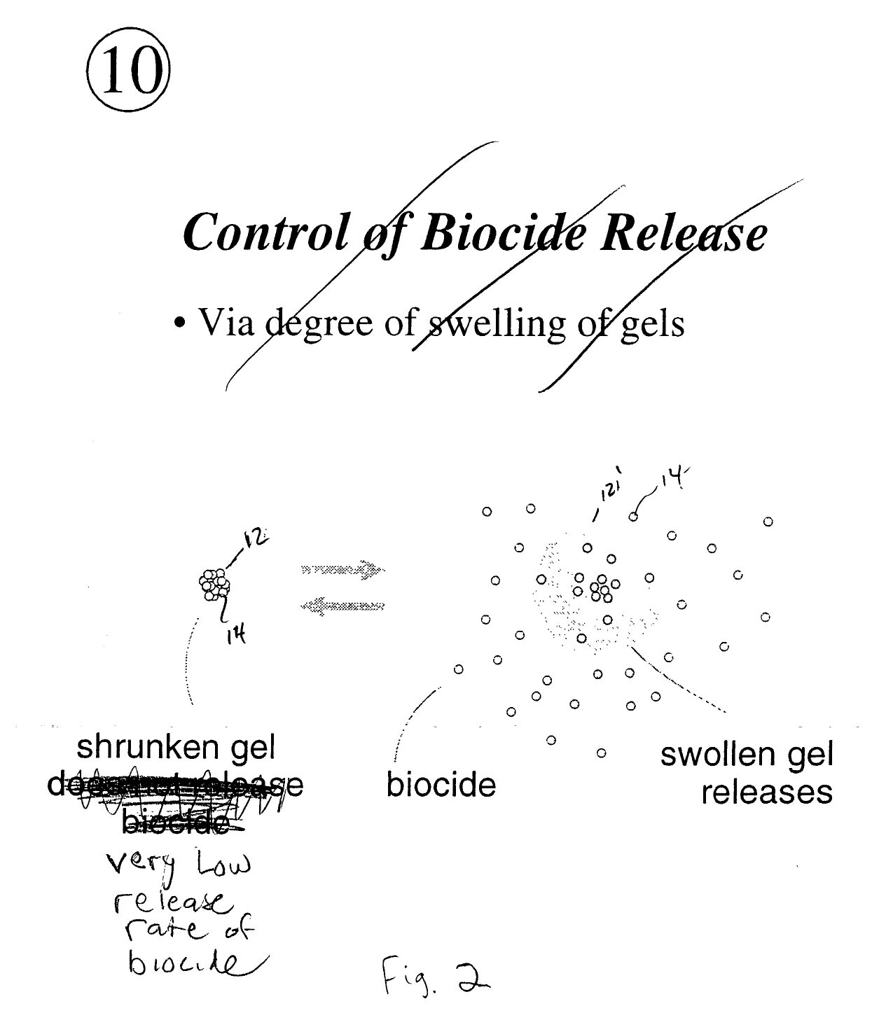

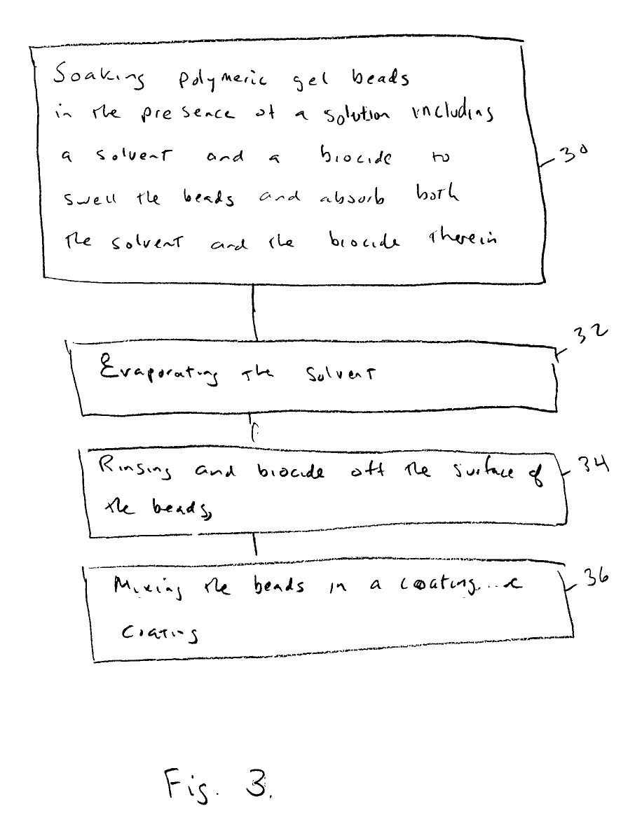

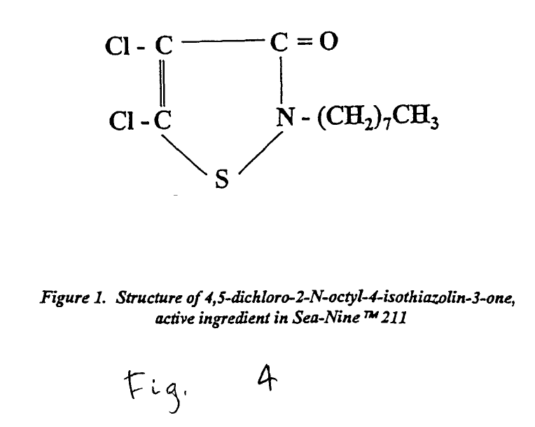

These prior art protective coatings cannot provide for sustained, controlled release of the biocide for extended periods of time. As shown in FIG. 1, the biocide release rate for these anti-fouling coatings falls to zero well before the typical 5 to 7 year docking interval that ships undergo for servicing.

SEA-NINE™ 211 is a recently developed organic anti-fouling agent. Prior art methods utilizing SEA-NINE™ 211 in marine coatings or paints are effective against bio-fouling organisms. However, because of the enhanced, uncontrolled release rates of SEA-NINE™ in seawater, these prior art coatings have a short lifetime.

The inventors hereof realized that utilizing a biocide, such as SEA-NINE™ 211 or IRGAROL® 1051, in conjunction with gel beads which remain in a collapsed state, result in very low biocide release rates when exposed to seawater or paint formulations.

Gel bead 12, FIG. 2 that always remains collapsed (shrunken) when exposed to water, seawater or paint formulations slowly releases biocide 14 encapsulated in bead 12. If the bead 12 expands when exposed to water, seawater or paint formulations, the biocide 14 will be released more rapidly, as shown by bead 12′.

The inventors hereof discovered one effective solution to create an effective anti-fouling coating is the incorporation of gel beads which encapsulate a biocide and also preferably using beads which remain in collapsed state when exposed to water, seawater, and the paint formulation. The collapsed gel beads then very slowly release the biocide therein and hence provide anti-fouling capabilities for extended periods.

One method of preparing an anti-fouling coating in accordance with this invention includes soaking polymeric gel beads in the presence of a solution including a solvent and a biocide to swell the beads and absorb both the solvent and the biocide therein, step 30, FIG. 3; evaporating the solvent, step 32; rinsing the biocide off the surface of the beads, for example, with a solution of hexane and water, step 34; and mixing the beads in a coating, such as a solvent based or water based paint (such as available from Kop-Coat Marine Group, Rockaway, N. J., manufacturers of Petit Marine Paints and Woolsey Paints), step 36. Typically, a mixture of two to five percent gel beads with encapsulated biocide therein is mixed with the paint. Ideally, the resulting beads have a diameter of less than 200 μm. In a preferred embodiment, the beads have a diameter of less than 50 μm. In one example, the polymeric gel beads are made of polystyrene. Polystyrene gel beads are preferred because they remain in a collapsed, stable state and very slowly release the biocide therein when exposed to water, seawater, or paint formulations. The polystyrene gels are commercially available in diameters of less than 50 μm, such as gels with a mesh size of 200 (75 μm) to 400 (38 μm), (Alpha Aesar Seal, Ward Hill, Mass.). In one embodiment of this invention, the polystyrene beads are crosslinked with divinyl benzene. Because the polystyrene gel beads always remain in collapsed stable state, the rate of the biocide release from the gel is very low. In one example, the release rate of the biocide from the gel beads mixed in the protective coating is less than 10 μg/cm²/day, which results in the ability to provide an anti-fouling coating which has an effective lifetime in the range of 5 to 7 years.

Ideally, the solvent used in accordance with the method of preparing an anti-fouling coating of this invention is xylene. In other examples, the solvent is acetone, benzene, toluene, chloroform, dichloroform, dichloromethane and tetrahydrofuran. In one example, the biocide is a 30% solution of 4,5-dichloro-2-N-octyl-4-isothiazolin-3-one in xylene, such as SEA-NINE™ 211 (Rohm and Haas, Philadelphia, Pa.). The chemical structure of 4,5-dichloro-2-N-octyl-4-isothiazolin-3-one, the active ingredient of SEA-NINE™ 211 is shown in FIG. 4.

In one embodiment of this invention, dry beads of polystyrene gels crosslinked at 2% by divinylbenzene were allowed to swell in a 30% solution of SEA-NINE™ 211 and xylene for 24 hours. The swollen gel was separated from the liquid phase, rinsed with water and hexane to prevent the gel beads from clumping together, and air-dried in a fume-hood. Typical biocide encapsulation in the gel in this example is approximately 20 percent, although biocide encapsulation in the gel may be less than or greater than 20 percent.

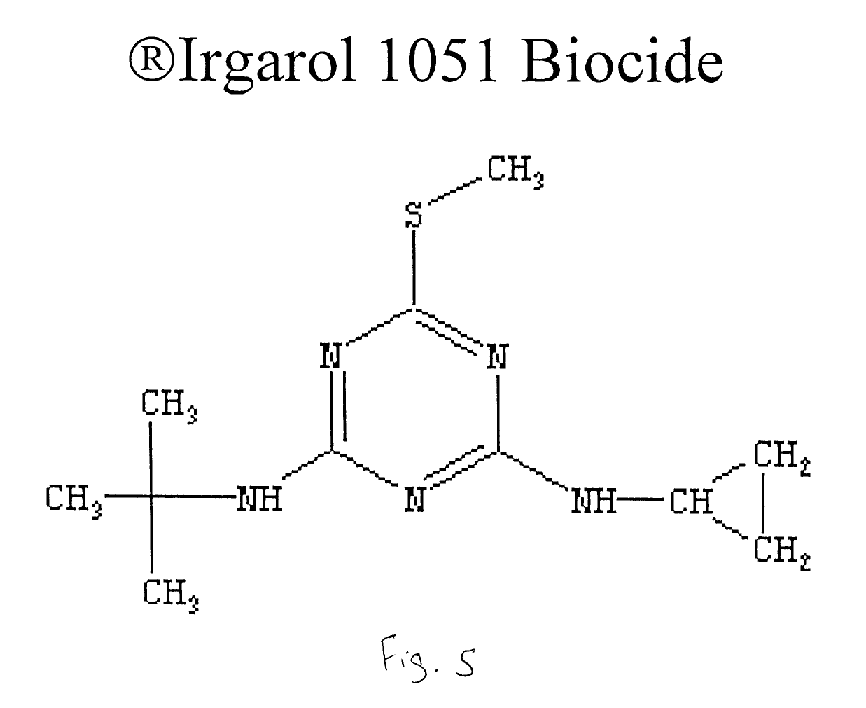

In other embodiments in accordance with this invention, the biocide IRGAROL® 1051, an s-triazine compound, (available from Ciba Specialty Chemicals Additives Division, Tarrytown, N.Y.) is encapsulated in the polymeric gel beads. The chemical structure of IRGAROL® 1051 is shown in FIG. 5. In other examples, the biocide encapsulated in the polymeric gel beads is copper, a mixture of copper and IRGAROL® 1051 or mixture of copper and SEA-NINE™ 211. In one embodiment, the release rate of a chosen biocide (e.g., SEA-NINE™ 211, IRGAROL® 1051, copper, or a mixture of copper and SEA-NINE™ 211, or copper and IRGAROL® 1051) and from the gel beads mixed with a protective coating is sufficient to inhibit the attachment of fouling organisms to the surface of marine vessels.

Typically, the anti-fouling coating produced by the method of this invention is applied to the hull of a sea vessel or other sea structure, such as floating platforms, seawater piping systems and other fixed structures located near the surface of the sea. The innovative coating provides for controlled, sustained release of the biocide for extended periods of time, such as the interval between dry-docking of ships.

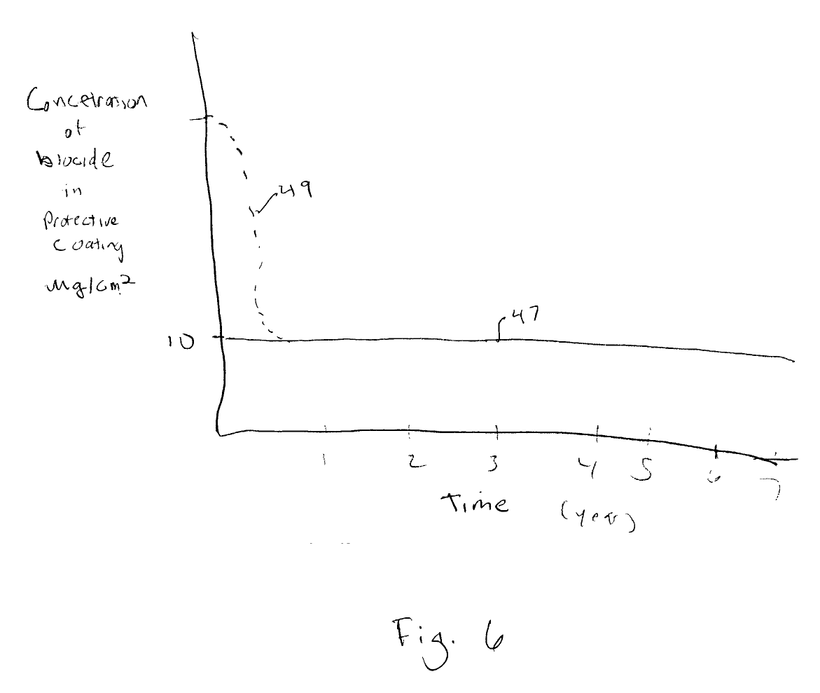

The simple and effective method of preparing an anti-fouling coating of this invention only requires soaking the beads in the presence of a solution of biocide to swell the beads to absorb the solvent and the biocide, evaporating solvent from the gel beads, and rinsing as residue solvent/biocide from the gel beads. The gel beads then return to a collapsed state and are mixed with a protective coating. Because the beads are composed of a material which remains in a collapsed stable form when exposed to seawater, the biocide is very slowly released from the gel, as indicated by graph 47, FIG. 6. The result is an anti-fouling coating which is effective for extended periods of time, such as the 5 to 7 year dry-docking interval.

Moreover, biocides such as SEA-NINE™ 211 or IRGAROL® 1051 may cause eye irritation and skin sensitization. The handling and application of marine paints containing these biocides will be made easier if the biocides are encapsulated in the gel beads.

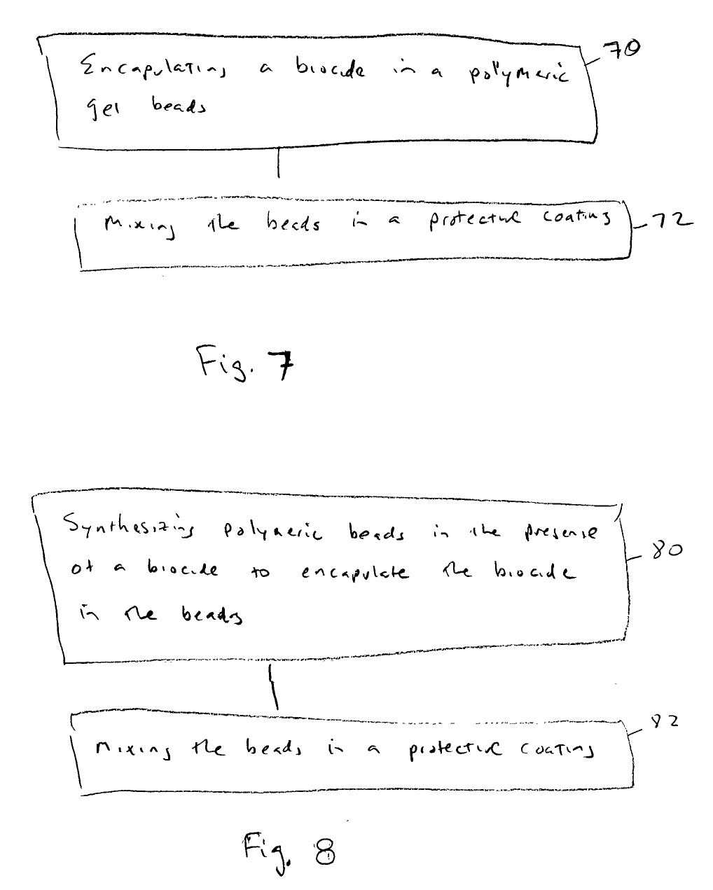

In one embodiment, the method of preparing an anti-fouling coating includes encapsulating a biocide in polymeric gel beads, step 70, FIG. 7, and mixing the beads in a protective coating, step 72.

In another embodiment of this invention, the inventors hereof developed a method of preparing an anti-fouling coating based on responsive phase transition gel technology, developed by one of the inventors hereof, T. Tanaka. See Tanaka, T., “Collapse of Gels and the Critical Endpoint,” Phys. Rev. Lett., Vol. 40, pp. 820-823, 1978; Tanaka, T., “Gels” Sci. Am., Vol. 244, pp. 124-138, January, 1981; Li, Y. and Tanaka, T., “Phase Transitions of Gels,” Annu. Rev. Mater. Sci., Vol. 22, pp. 243-77, 1992, and U.S. Pat. Nos. 4,723,930; 5,242,491; 5,100,933; and 5,801,211, all incorporated herein their entirety by this reference. Tanaka discovered that the volume phase transition of gels is universal by observing the phenomenon in gels with widely different chemical compositions. There are four fundamental intermolecular forces which contribute to the various types of phase transition in polymer gels. These forces include: 1) van der Waals forces, 2) hydrogen bonding, 3) hydrophobic interactions, and 4) ionic interactions. Examples of how each of these forces can cause a polymer gel phase transition are given below.

Van der Waals: The phase transition of hydrophilic polymer gel networks in water occurs when the interaction between the polymer chains and water is overcome by van der Waals forces between polymer chains. If the water is mixed with alcohol or acetone, the effect of the van der Waals forces is enhanced, and the polymer gel collapses.

Hydrogen bonding: Polymer complexes formed in interpenetrating networks of poly(acrylic acid) and poly(acrylamide) exhibit phase transitions when the hydrogen bonds that form the complexes form or break. Hydrogen bonds become less stable as the temperature is increased.

Hydrophobic interactions: Non-polar polymer gel chains in water, a polar solvent, are shielded from one another by a cage of highly ordered water molecules at lower temperatures. This cage becomes less stable at higher temperatures, the non-polar polymer chains are no longer as well shielded, and the polymer chains attract one another, causing the gel to collapse.

Ionic interactions: The relative degree of ionization of polymer gel chains determines the magnitude of the discontinuity observed during the phase transition. Ionizable polymer networks can be obtained by several ways including: a) copolymerizing ionizable molecules into the network, b) hydrolysis, and c) light illumination. Ionized networks are sensitive to pH, salt, electric fields, and light. Once the ionized gels are prepared, the degree of ionization can be controlled in several ways including introducing disassociable chemicals into the network, and varying salt concentration and pH.

The phase transition is a result of a competitive balance between a repulsive force that acts to expand the polymer gel network and attractive forces that act to shrink the network. The most effective repulsive force is the electrostatic interaction between polymer charges of the same kind. This force can be imposed upon a gel by introducing ionization into the network, the greater the ionization the larger the volume change at a discontinuous transition. The osmotic pressure by counter-ions adds to the expanding pressure. The attractive forces can be van der Waals, hydrophobic interactions, ion-ion interactions between opposite kinds of charges, and hydrogen bonding.

Tanaka discovered phase transition in gels induced by each of the four fundamental forces shown above, i.e. van der Waals forces, hydrogen bonding, hydrophobic interactions, and ionic interactions may each independently be responsible for a discontinuous volume transition in polymer gels. The combination and proper balance of these four forces lead not only to a single volume phase transition of these gels, but also to multiple phase transitions between various stable phases characterized by a distinct degree of swelling.

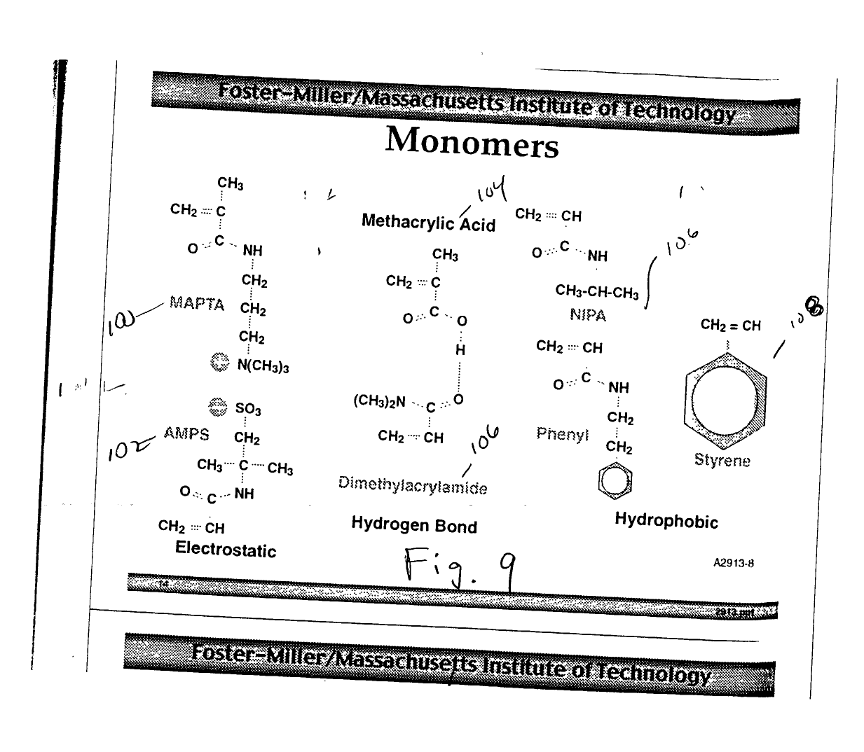

The method of preparing an anti-fouling coating, in one preferred embodiment of this invention, utilizes phase transition gels which can encapsulate a biocide therein. The method includes synthesizing gel beads in the presence of a biocide to encapsulate the biocide in the beads, step 80, FIG. 8, and mixing the beads with a protective coating, step 82. Ideally, the synthesized gel beads are polymeric network cross-linked beads. In one example, the method further includes the steps of grinding the polymeric beads to a diameter of less than 50 μm and washing the polymeric beads to remove biocide from the surface of the beads.

In one example, the biocide is solid, such as copper, 4,5-dichloro-2-N-octyl-4-isothiazolin-3-one, or IRGAROL® 1051. In other examples, the biocide is SEA-NINE™ 211 (isothiazolone in xylene), or IRGAROL® 1051 (s-triazine in chloroform).

In one embodiment, monomers, such as MAPTA ([3-(methacrylamino)propyl] trimethylammonium chloride) 100 and AMPS (2-acrylamido-2-methyl-1-propane-sulfonic acid) 102, FIG. 9 which interact by electrostatic interactions are used to synthesize the polymeric gel beads. In other examples, methacrylic acid 104 and dimethylacrylamide 106, which interact by hydrogen bonding are used. In another example, NIPA 106 and polystyrene gel 108, which interact by hydrophobic interaction may be used to synthesize the polymeric gels.

Combinations of these monomers are chosen such that: 1) there is a specific affinity between the biocide molecules and polymers to insure a controlled steady release rate of the biocide into seawater; 2) the polymeric network is in a stable form in seawater, namely, the polymer network containing the organic biocides must be in a collapsed phase in the coating formulation and in seawater; 3) the polymeric gels must form a strong complex with the biocide to insure a slow release rate of the biocide into seawater; 4) the gels should have a large storage capacity for the biocide; 5) the molecular design should be generic and modifiable for different biocide molecules; and 6) the release rate does not exceed 10 μg/cm2/day, or depending on the particular biocide chosen, a value sufficient to inhibit the attachment of fouling organisms to the surface of a marine vessel.

In one preferred embodiment, the phase transition gels synthesized in accordance with this invention encapsulate organic biocides, such as SEA-NINE™ 211, or IRGAROL® 1051 into the gel beads. The gels then released very small quantities of the biocide upon exposure to water in a prolonged, steady manner. These gels are different than conventional phase transition gels because a predefined stimulus is not required for the release of the biocides. The polymeric network gel beads synthesized in accordance with the method of preparing an anti-fouling coating remain in a collapsed state within the protective coating such that the diffusion of the biocides out of the gel is prolonged and very slow upon exposure to seawater. There is an initial fast release of the biocide from the protective coating because of residue biocide present on the surface of the beads and a small amount of gel beads which are damaged from the grinding process, as indicated by the dashed part of graph 49, FIG. 6. However, because the gel beads are synthesized such that they remain in a collapsed stable form when exposed to seawater, the biocide is very slowly released from the gel of the anti-fouling coating, and can provide anti-fouling for extended periods of time, as indicated by the solid part of graph 47, FIG. 6.

The result is an anti-fouling coating which is effective for extended periods of time, such as 5 to 7 years. Moreover, placing a protective coating over biocides such as SEA-NINE™ 211 or IRGAROL® 1051, which by themselves may cause eye irritation and skin sensitization, results in a marine paint which is easier and more environmentally friendly to handle.

### EXAMPLES

The following examples are meant to illustrate and not limit the present invention. Unless otherwise stated, all parts therein are by weight.

### Examples 1 and 2

### Gel Formation Strategy

One homopolymer and two heteropolymer gels having different monomer compositions were synthesized. The monomers were capable of achieving different fundamental chemical interactions, namely hydrogen bonding, hydrophobic, electrostatic and van der Waals interactions. The gels were synthesized using template (imprinting) polymerization techniques in which the monomers, cross-linkers and initiators were mixed together and allowed to interact freely with each other. The mixtures were polymerized after they equilibrated. Several acrylamide-derivative monomers were used, which have the chemical formula: CH₂═CH—CO—NH—CH₂—CH₂—R, where R indicates one of several functional groups. The monomers were chosen in such a way that the functional group R and the vinyl group CH₂═CH—, which was to be polymerized, were a sufficient distance from each other to insure the same reaction rate for all the monomers with different functional groups.

### Example 1

N-Isopropylacrylamide Gel Synthesis

An N-isopropylacrylamide gel where R═CH(CH₃)₂ (isopropyl, hydrophobic group) was synthesized. The gel was prepared by dissolving 700 mM of N-isopropylacrylamide in deionized, distilled water with 8.6 mM (0.0133 g) of N,N-methylenebisacrylamide ((CH₂═CHCONH)₂CH₂) crosslinker. The polymerization was initiated by adding 20 mg of ammonium persulfate as an accelerator to 100 mL of a pre-gel solution at a temperature of 60° C. under a nitrogen atmosphere. The N-isopropylacrylamide gel is a typical hydrophobic homopolymer (single component) gel that was found to be able to strongly absorb the SEA-NINE™ 211 biocide and remain collapsed in seawater.

### Example 2

### Five Component Gel Syntheses

A five-component gel was synthesized where five different monomers were included in the polymer network. The monomers were

1) H₂C═C(CH₃)COOH, methacrylic acid (MAAc), a hydrogen bondable group;

2)-R═N(CH₃)₂, dimethylacrylamide (DMAAm), a hydrogen bondable group;

3)-R═C(CH₃)₃, N-tertial butylacrylamide (NTBA), a hydrophobic group;

4)-R═CH₂(CH₃)₂SO₃H, acrylamidomethylpropyl sulfonic acid (AMPS-H), an electrostatic (anionic) group; and

5)-R═CH₂CH₂CH₂N(CH₃)₃Cl, methacryl-amidopropyl-trimethyl-ammonium-chloride (MAPTA-Cl), an electrostatic (cationic) group.

A MAPTA-AMPS paired aqueous solution was prepared by initially dissolving 0.2 moles of AMPS-H in 80 mL of water; the solution was kept cool in an ice bath to prevent polymerization. While the AMPS-H solution was being stirred, 0.1 moles of Ag₂CO₃ was slowly added to produce carbon dioxide and AMPS-Ag. The solution was then centrifuged at 3000 rpm and filtered through a 0.2 μm filter. After adding MAPTA-Cl, the resulting AgCl precipitate was filtered out using a 0.2 μm filter. Small aliquots of the MAPTA-AMPS were tested to ensure the solution had an equal concentration of AMPS and MAPTA monomers. The balanced stock solution was diluted to a concentration of 0.5M each of MAPTA and AMPS; 15 g of the solution were prepared. The other three monomers were then added in the following quantities: DMAAm, 2.0M, 5.95 g; MAAc, 2.0M, 5.17 g; and NTBA, 1M, 3.81 g. The gels were then made using 10 mM (0.0463 g) N,N-methylenebisacrylamide as a cross-linker and 5 mM (0.0342 g) ammonium persulfate as an initiator; and finally, additional water was added to give a total solution weight of 30 g. The gelation temperature was 60° C. under a nitrogen atmosphere.

The five-component gels were prepared in two ways to study the effect of polymerization on biocide release. The first method, described above, used water as a solvent. In the second method, an organic solvent (methyl sulfoxide) was used instead of water and the initiator was azobisisobutyronitrile. It was expected that hydrogen bonding was more effective in the latter gel because the gel was synthesized in a solvent where the hydrogen bonding was intact and imprinted into the gel structure.

The five component gel is a heteropolymer gel that remains collapsed in seawater, but should more strongly absorb the SEA-NINE™ 211 biocide because of the more bondable groups.

### Example 3

### Soaking the Prepared Gels in SEA-NINE™ 211

The three gels were prepared in bulk form. Each gel was crushed into a particulate form by forcing the bulk material through a No. 40 (425 μm sieve opening) standard testing sieve with a small amount of deionized water. The gels were filtered out of the water and partially air-dried in a fume hood prior to being exposed to the SEA-NINE™ 211 biocide. The gels were impregnated with SEA-NINE™ 211 by immersing them in the biocide for two hours with gentle stirring. After two hours the gels were filtered out of the solution and were rinsed extensively with water to remove any SEA-NINE™ 211 from the surface of the gel. The quantity of SEA-NINE™ 211 retained by the gel was determined by measuring the concentration and quantity of the biocide before and after contact with the gels, including the amount of SEA-NINE™ 211 in the rinse waters. The amount of SEA-NINE™ 211 the N-isopropylacrylamide gel was determined to be 244-245 mg, or a loading of close to 100 percent. For the five component gels, the gels contained 173 to 213 mg, or a loading of 35 to 43 percent. All three gels were air-dried in a fume hood and crushed with a mortar and pestle producing a fine, grayish white powder with dimensions of less than 50 μm.

### Example 4

### Synthesis of the Gel in the Presence of the Biocide: Five Component Gel

The five component gel was prepared as in example 2, except that a solid biocide, such as 4,5-dichloro-2-N-octyl-4-isothiazolin-3-one or a liquid biocide such as SEA-NINE™ 211 in xylene was added before polymerization was performed and before the monomer solutions were brought up to their final weight of 30 g. Otherwise, the synthesis was conducted in an identical manner to example 2. The second step of soaking the gel in the biocide solution (Example 3) was unnecessary in this example.

### Example 5

### Encapsulation of IRGAROL® 1051 in Polystyrene Gel

In another example of this invention, dry beads of polystyrene crosslinked at 1% by divinylbenzene were allowed to swell in a 20% solution of IRGAROL® 1051 in chloroform for 24 hours. The swollen gel was separated from the liquid phase, rinsed with acetone to remove the excess of unencapsulated IRGAROL® 1051 and to prevent the gel beads from clumping together, and air-dried in a fume hood. A typical biocide encapsulation loading was approximately 20 percent.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A method of preparing an anti-fouling coating, the method comprising:
soaking polymeric gel beads in the presence of a solution including a solvent and a biocide to swell the beads and absorb both the solvent and the biocide therein;
evaporating the solvent;
rinsing any biocide of the surface of the beads; and
mixing the beads in a coating material.

2. The method of preparing an anti-fouling coating of claim 1 in which the beads have a diameter of less than 200 μm.

3. The method of preparing an anti-fouling coating of claim 1 in which the beads have a diameter of less than 50 μm.

4. The method of preparing an anti-fouling coating of claim 1 in which the polymeric gel beads are made of polystyrene.

5. The method of preparing an anti-fouling coating of claim 1 in which the polystyrene beads are crosslinked with divinylbenzene.

6. The method of preparing an anti-fouling coating of claim 1 in which the solvent dissolves the biocide and swells the gel beads.

7. The method of preparing an anti-fouling coating of claim 6 in which the solvent is chosen from the group consisting of xylene, acetone, benzene, toluene, chloroform, dichloroform, dichloromethane and tetrahydrofuran.

8. The method of preparing an anti-fouling coating of claim 7 in which the biocide is a 30 percent solution of 4,5-dichloro-2-N-octyl-4-isothiazolin-3-one in xylene.

9. The method of preparing an anti-fouling coating of claim 7 in which the biocide is SEA-NINE™ 211.

10. The method of preparing an anti-fouling coating of claim 7 in which the biocide is IRGAROL® 1051.

11. The method of preparing an anti-fouling coating of claim 1 in which the biocide is copper.

12. The method of preparing an anti-fouling coating of claim 1 in which the biocide is a mixture of copper and SEA-NINE™ 211.

13. The method of preparing an anti-fouling coating of claim 1 in which the biocide is a mixture of copper and IRGAROL® 1051.

14. The method of preparing an anti-fouling coating of claim 1 in which 20 percent or more of the biocide is encapsulated in the gel beads.

15. The method of preparing an anti-fouling coating of claim 1 in which 20 percent or more of SEA-NINE™ 211 is encapsulated in the gel beads.

16. The method of preparing an anti-fouling coating of claim 1 in which the gel beads are chosen such that they remain collapsed when exposed to seawater or paint formulations.

17. The method of preparing an anti-fouling coating of claim 1 in which the release rate of the biocide from the gel beads mixed in the protective coating is less than 10 μg/cm²/day.

18. The method of preparing an anti-fouling coating of claim 1 in which the release rate of a chosen biocide from the gel beads mixed in the protective coating is sufficient to inhibit the attachment of fouling organisms to the surface of a marine vessel.

19. The method of preparing an anti-fouling coating of claim 1 in which the effective lifetime of the anti-fouling coating is in the range of 5 to 7 years.

20. The method of preparing an anti-fouling coating of claim 1 in which the coating is paint.

21. The method of preparing an anti-fouling coating of claim 1 in which the anti-fouling coating is applied to the hull of a sea vessel.

22. The method of preparing an anti-fouling coating of claim 1 in which the coating is applied to floating platforms, seawater piping systems, and other fixed structures located near the surface of the sea.

23. A method of preparing an anti-fouling coating, the method comprising:
soaking polymeric gel beads in the presence of a solution including a solvent and a biocide to swell the beads and absorb both the solvent and the biocide therein;
evaporating the solvent; and
mixing the beads in a protective coating.

24. A method of preparing an anti-fouling coating, the method comprising:
choosing polymeric gel beads which remain collapsed when exposed to seawater and paint formulations;
soaking the polymeric beads in the presence of a solution including a solvent and a biocide to swell the beads and absorb both the solvent and the biocide therein;
evaporating the solvent to collapse the beads; and
mixing the beads in a coating material.

25. A method of preparing an anti-fouling coating, the method comprising:
encapsulating a biocide in polymeric gel beads; and
mixing the beads in a protective coating.

26. The method of preparing an anti-fouling coating of claim 25 in which the coating is paint.

27. The method of preparing an anti-fouling coating of claim 25 in which the coating is applied to the hull of a sea vessel.

28. The method of preparing an anti-fouling coating of claim 25 in which the coating is applied to the hull of floating platforms, seawater piping systems, and other fixed structures located near the surface of the sea.

29. The method of preparing an anti-fouling coating of claim 25 in which the release rate of the biocide from the gel beads mixed in the protective coating is less than 10 μg/cm²/day.

30. The method of preparing an anti-fouling coating of claim 25 in which the release rate of a chosen biocide from the gel beads mixed in a protective coating is sufficient to inhibit the attachment of fouling organisms to the surface of a marine vessel.

31. The method of preparing an anti-fouling coating of claim 25 in which the effective lifetime of the anti-fouling coating is in the range of 5 to 7 years.

32. The method of preparing an anti-fouling coating, the method comprising:
synthesizing gel beads in the presence of a biocide to encapsulate the biocide in the beads;
evaporating any solvents; and
mixing the beads in a protective coating.

33. The method of preparing an anti-fouling coating of claim 32 in which gel beads are polymeric network cross-linked beads.

34. The method of preparing an anti-fouling coating of claim 32 further including the step of washing the polymeric beads to remove biocide from the surface of the beads.

35. The method of preparing an anti-fouling coating of claim 32 further including the step of grinding the polymeric beads to a diameter of less than 50 μm.

36. The method of preparing an anti-fouling coating of claim 32 in which the biocide is solid.

37. The method of preparing an anti-fouling coating of claim 36 in which the biocide is copper.

38. The method of preparing an anti-fouling coating of claim 36 in which the biocide is 4,5-dichloro-2-N-octyl-4-isothiazolin-3-one.

39. The method of preparing an anti-fouling coating of claim 36 in which the biocide is IRGAROL® 1051.

40. The method of preparing an anti-fouling coating of claim 32 in which the biocide is SEA-NINE™ 211 in xylene.

41. The method of preparing an anti-fouling coating of claim 32 in which the biocide is IRGAROL® 1051 in chloroform.

42. The method of preparing an anti-fouling coating of claim 32 in which the polymeric gel beads are synthesized by free-radical polymerization.

43. The method of preparing an anti-fouling coating of claim 42 in which the monomers are chosen such that the monomers interact by hydrogen bonding, electrostatic interaction, van der Waals interaction, or hydrophobic interactions.

44. The method of preparing an anti-fouling coating of claim 38 in which the monomers are chosen from the group consisting of MAPTA-Cl, AMPS, methacrylic acid, dimethylacrylamide, and N-isopropylacrylamide.

45. The method of preparing an anti-fouling coating of claim 32 in which the release rate of the biocide from the gel beads mixed in the protective coating is less than 10 μg/cm²/day.

46. The method of preparing an anti-fouling coating of claim 32 in which the release rate of a chosen biocide from the gel beads mixed in the protective coating is sufficient to inhibit the attachment of fouling organisms to the surface of a marine vessel.

47. The method of preparing an anti-fouling coating of claim 32 in which the effective lifetime of the anti-fouling coating is in the range of 5 to 7 years.

48. The method of preparing an anti-fouling coating of claim 32 in which the coating is applied to the hull of a sea vessel.

49. The method of preparing an anti-fouling coating of claim 32 in which the coating is applied to the hull of floating platforms, seawater piping systems, and other fixed structures located near the surface of the sea.
